(19) United States
(12) Patent Application Publication
(10) Pub. No.: US 2022/0090862 A1
(43) Pub. Date: Mar. 24, 2022

(54) FURNACE WITH MOVABLE BEAM LOAD HANDLING SYSTEM

(71) Applicant: SMS GROUP S.p.A., Tarcento, UDINE (IT)

(72) Inventor: Jimmy FABRO, UDINE (IT)

(21) Appl. No.: 17/431,828

(22) PCT Filed: Feb. 19, 2020
(86) PCT No.: PCT/IB2020/051357

§ 371 Date: Aug. 18, 2021

(30) Foreign Application Priority Data
Mar. 5, 2019 (IT) 102019000003151

(51) Int. Cl. F27B 9/20; F27D 3/02; C21D 9/70; C21D 9/00

(52) U.S. Cl. CPC F27B 9/202; F27D 3/022; F27D 2003/0095; C21D 9/0081; C21D 9/70

(57) ABSTRACT

Furnace with movable beam load handling system, in particular for heating or heat treatment of ferrous or non-ferrous metallic material, comprising:—a furnace chamber extending between a furnace-loading section and a furnace-unloading section of the material along a longitudinal direction;—first beams, arranged inside said chamber and defining a plurality of main supports for the material to be treated in said chamber,—second beams, arranged inside said chamber and defining a plurality of temporary supports for the material, wherein said second beams are cyclically movable with respect to the first beams so as to impart to said material a movement between said furnace-loading section and said furnace-unloading section having a motion component parallel to said longitudinal direction.

### FIELD OF THE INVENTION

The present invention relates to a furnace with movable beam load handling system.

The furnace according to the present invention is a furnace adapted to operate on any iron and steel semi-finished or finished product (slabs, billets, blooms, tubes, etc.).

The furnace according to the present invention finds particular application in the heating and heat treatment of materials of iron and steel plants and non-ferrous metallic materials.

### STATE OF THE ART

As is well known, one of the main problems tied to the handling of products within furnace chambers, be they for heating or heat treatment, is due to the cooling of the materials subjected to heating/heat treatment in a localised area in the point of contact between the material and the support (also known as “beam”) whereon it rests.

This localised cold area, technically called “skid mark”, can generate problems in the subsequent step of rolling the heat-treated material. Since rolling consists of a plastic deformation applied to the mass of the material, having areas at different temperature within the mass causes, being deformation stress equal, a different residual tension state between them, with consequent formation of cracks that may have even severe repercussions in subsequent work processes or in the finished product.

Localised cooling occurs for two distinct reasons.
direct contact between material and support (beam): in heating furnaces, the mass of the material to be treated is generally considerable, and if temperatures are high the structures on which the material rests must necessarily be cooled, so as to preserve their structural integrity; the cooling of the structure inevitably causes the generation of a cold point that generates the localised cooling of the mass of material to be heated;
reduction of the radiative heat exchange due to the shadow generated by the support: the presence of a bearing support for the mass to be heated prevents the part affected by the support to be heated like the rest of the free surface; this is due to the fact that the main heat transport mechanism inside a furnace is radiative, and the support performs a screening function.

The problem of localised cooling is present in the two main technological solutions for furnaces able to assure bilateral heating, i.e. heating that occurs on both exposed surfaces of the material: pusher furnaces and walking beam furnaces.

In pusher furnaces the material is moved within the chamber of the furnace thanks to the push received from a dedicated machine, called “pusher’, that transmits the advancing motion to all pieces present in the furnace; in this case the supports (beams) are fixed and the material slides over them. These furnaces have limitations with respect to the characteristics that the load to be treated must have. To assure a correct push, the surfaces in contact between the two adjacent pieces must be similar.

In walking beam furnaces, on the contrary, the material to be heated advances inside the furnace thanks to the action of movable supports. In this case, the material rests on fixed supports and at the time of the advance the movable supports, which in resting position are at a lower height than the fixed ones, rise and detach the material from the fixed supports. Subsequently, remaining raised they induce an advancing motion of the material. When the advance ends, they are lowered to make the material rest once again on the fixed support in a more advanced position. After setting the material on the fixed supports, the movable supports go back to the starting position to restart the cycle.

The advantages of walking beam furnaces, compared to pusher furnaces, are essentially two:
it is possible to treat materials with very different geometries;
it is possible to empty to furnace or to generate gaps between different production lots, assuring flexibility in heating conditions and greater ease of access during maintenance work.

The disadvantage of walking beam furnaces, compared to pusher furnaces fitted only with fixed beams, is tied to the increase in the number of supports within the furnace. This leads to an increase in the areas subject to localised cooling, since the supports must be cooled to assure their structural integrity over time.

To minimise the phenomenon of localised cooling on the material, different strategies have been devised, which may be grouped in two main classes:
inclining and offsetting the beams: the beams do not continuously travel through the furnace chamber from the loading door to the unloading door, but they are constructed in different segments, not mutually aligned and inclined with respect to the longitudinal axis of the furnace;
use of materials with low thermal conductivity for the construction of the structures in direct contact with the material to be treated or construction of particular shapes of these structures.

The first strategy actually assures a reduction of the cold area inasmuch as, alternating the area of the material in which contact with the support is generated, the time necessary for the formation of a sizable cold spot is not provided, but it ceases to be valid in case of plant downtime. If production has to be stopped, for example because of a problem downstream of the plant (for example at the rolling mill), the pieces of material are no longer moved from their position and formation of the cold spot is inevitable.

Moreover, the frequency, with which the contact area between material and support beams is alternated, is tied to the misalignment between the beams along the longitudinal development of the furnace and thus to the construction characteristics of the furnace. This reduces the operating flexibility in the control of the formation of the cold spots on the material.

The second strategy comprises an enormous number of solutions, among which we mention:
solution described in the U.S. Pat. No. 3,445,050: it provides for the construction of a particular structure, called “rider”, on which the material to be treated rests and that avoids direct contact with the cold beam; this situation is still used to this day;
solution described in the U.S. Pat. No. 3,642,261: it provides a cooled beam provided with riders as in U.S. Pat. No. 3,445,050, but these are not aligned, but offset;
solution described in the U.S. Pat. No. 5,007,824: it has a dedicated combustion system for the reduction of cold spots.

The technological solutions proposed in the second strategy minimise the cooling effect of the beam due to direct contact, but do not reduce the cooling effect of the beam due to the shadow generated by the beam, which is translated in a cooling effect due to less heating.

At present, reducing the presence of cold areas is one of the main needs in the sector of industrial furnaces for materials of iron and steel plants and non-ferrous metallic materials, because it would allow to eliminate many of the problems that a non-uniform temperature distribution causes during the subsequent process for rolling such materials.

### PRESENTATION OF THE INVENTION

Therefore, the purpose of the present invention is to eliminate, or at least to attenuate, the aforementioned problems of the prior art, making available a furnace with movable beam handling system that allows to reduce the formation of cold spots in the material during the heating/heat treatment process inside the furnace in an operatively more flexible way.

A further purpose of the present invention is to make available a furnace with movable beam handling system that allows to reduce the formation of cold spots in the material during the heating/heat treatment process inside the furnace even if the material is not made to advance inside the furnace.

A further purpose of the present invention is to make available a furnace with movable beam handling system that is operatively simple to manage.

### DESCRIPTION OF THE DRAWINGS

The technical features of the invention are clearly identified in the content of the claims set out below and its advantages will become more readily apparent in the detailed description that follows, made with reference to the accompanying drawings, which represent one or more embodiments provided purely by way of non-limiting examples, in which:

FIG. 1 shows a section perspective view from above of a movable beam furnace according to a preferred embodiment of the present invention, illustrated with material to be treated positioned inside it and with some details omitted;

FIG. 2 shows an enlarged perspective view of a detail of the furnace of FIG. 1, shown with partially unloaded material, the better to illustrate its details;

FIG. 3 shows a partially cutaway view of the furnace of FIG. 1, with some parts omitted the better to highlight the load handling system positioned in a technical chamber obtained under a furnace chamber;

FIG. 4 shows an enlargement of the detail contained in the dashed box of FIG. 3 indicated as IV;

FIG. 5 shows an enlargement of the detail contained in the dashed box of FIG. 3 indicated as V;

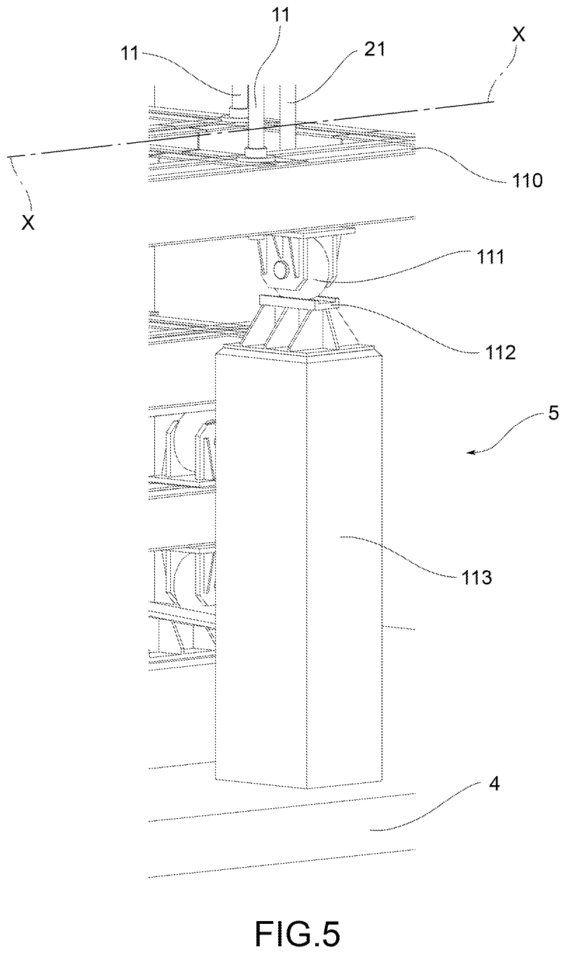

FIG. 6 is an orthogonal cross section view of the furnace of FIG. 1;

FIGS. 7 a-e are a series of five schematic views of the handling system of the furnace of FIG. 1 according to a longitudinal section, to illustrate in sequence the movements of second beams providing for the longitudinal advance of the load in the furnace of FIG. 1;

FIGS. 8 a-d show four schematic views of the handling system of the furnace of FIG. 1 according to a cross section, to illustrate in sequence the movements of first beams supporting the load and providing the transverse translation of the load in the furnace of FIG. 1, in case of handling with material in abutment; and

FIGS. 9 a-c show three schematic views of the handling system of the furnace of FIG. 1 according to a cross section, to illustrate in sequence the movements of first beams supporting the load and providing the transverse translation of the load in the furnace of FIG. 1, in case of handling with material not in abutment, but maintained raised by second beams providing the longitudinal advance of the load in the furnace of FIG. 1.

### DETAILED DESCRIPTION

With reference to the accompanying drawings, the numeral 1 indicates in its entirety a furnace with movable beam load handling system according to the invention.

The load may be defined by any type of semi-finished product or metallic material M, ferrous or non-ferrous, originating from casting operations (slabs, billets, blooms, ingots) or rolling operations or heat treatment (plates, bars, tubes).

The furnace 1 finds particular application in the heating or heat treatment of ferrous or non-ferrous metallic materials to be subjected to subsequent rolling operations.

The furnace 1 comprises a furnace chamber 2 extending between a furnace-loading section 2a and a furnace-unloading section 2b of the material M along a longitudinal direction X-X.

In particular, the furnace chamber 2 is enclosed in a containment structure 6 (only partially illustrated in the Figures), that can be made of refractory or insulating material and that comprises a hearth or bottom 3. Preferably, the containment structure 6 is kept in raised position with respect to a support base 4 of the furnace through a support structure 9 (in particular metallic) so that underneath the hearth 3 a technical chamber 5 is defined.

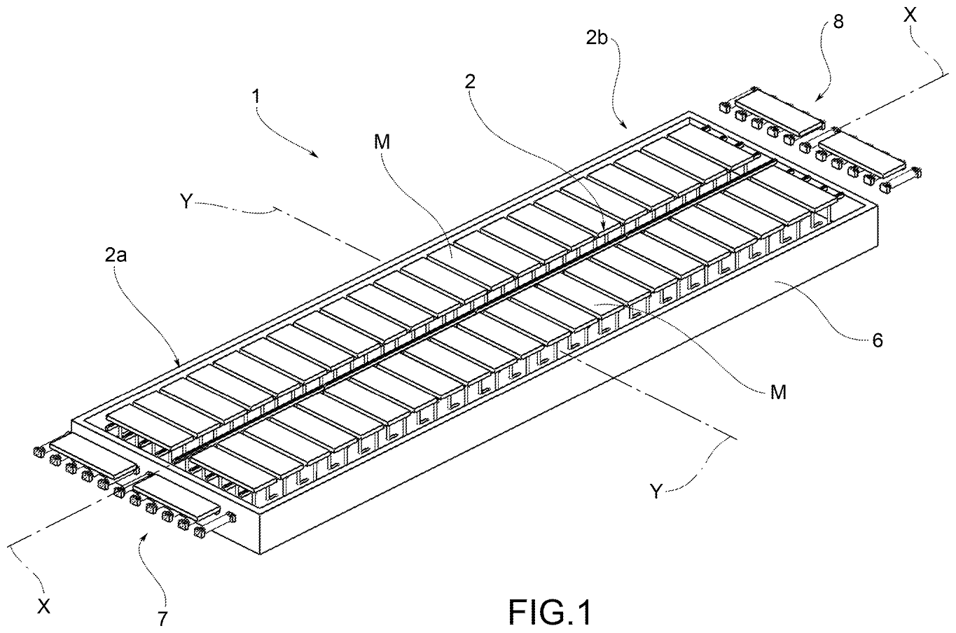

Advantageously, the furnace 1 comprises a furnace-loading device of the load 7, able to introduce the load of material M in the furnace, and a furnace-unloading device of the load 8, able to extract the load of material M in the furnace. The two devices 7 and 8, illustrated only schematically in FIG. 1, are known in themselves and will not be described in detail.

The furnace 1 can be equipped with any heating system (not illustrated in the accompanying figures), which can use both fuel and other heat sources.

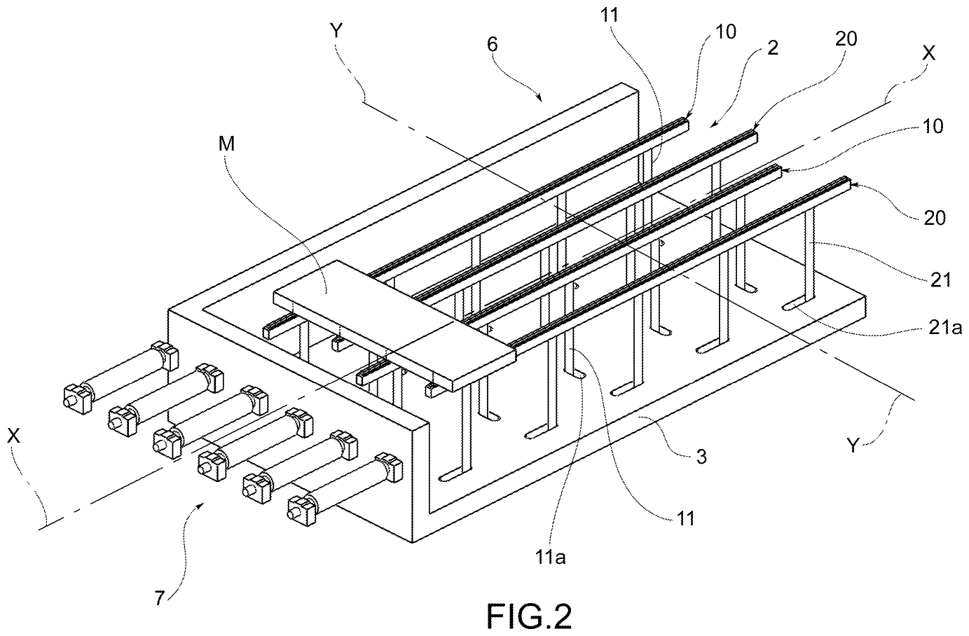

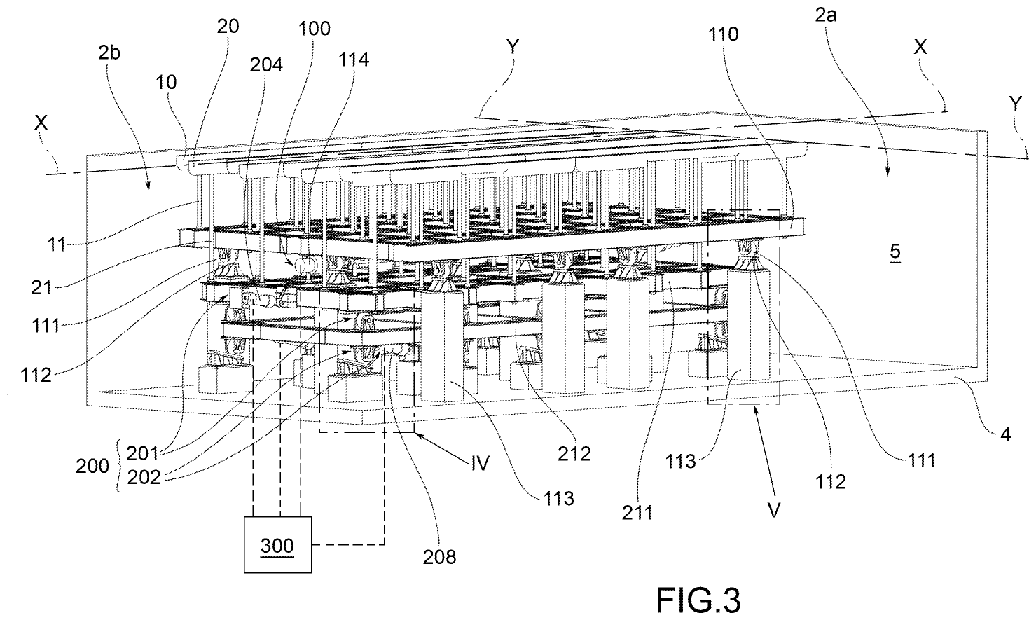

As illustrated in particular in FIGS. 2 and 3, the furnace 1 comprises first beams 10, which are positioned inside the chamber 2 and define a plurality of main supports for the material M to be treated in the chamber 2.

Said main beams (each of which can be formed by a single first beam or by two or more first beams aligned or substantially aligned) extend in length between said furnace-loading section 2a and said furnace-unloading section 2b. Said main supports are spaced transversely apart from each other to sustain horizontally the material M in different transverse positions inside the furnace chamber 2, maintaining it raised from the hearth or bottom 3 of the chamber 2 so as to allow a bilateral heating thereof (i.e. both from above and from below).

The furnace 1 further comprises second beams 20, which are positioned inside the chamber 2 and define a plurality of temporary supports for the material M to be treated in the chamber 2.

Said temporary supports also extend in length between the furnace-loading section 2a and the furnace-unloading section 2b. Said temporary beams (each of which can be formed by a single second beam or by two or more second beams aligned or substantially aligned) are spaced transversely apart from each other and alternating with said main supports.

Said second beams 20 are cyclically movable with respect to the first beams 10 so as to impart to said material M a movement between the furnace-loading section 2a and the furnace-unloading section 2b having a motion component parallel to said longitudinal direction X-X.

Operatively, the second beams 20 define the handling system of the load of material M inside the chamber 2, allowing to make it advance towards the furnace-unloading section 2b, or to make it move back towards the furnace-loading section 2a. The motion of the material is progressive, in steps. The single piece of material crosses longitudinally the entire chamber 2, pushed multiple times by different second beams 20 positioned between the furnace-loading section 2a and the furnace-unloading section 2b.

In particular, both the first beams 10, and the second beams 20 are structures made of steel, usually coated by refractory material, which can be cooled or not.

According to the invention, the first beams 10, or the second beams 20, or both the first beams 10 and the second beams 20, are movable with respect to the furnace chamber 2 with movements having a motion component Y-Y transverse to said longitudinal direction X-X (hereafter also transverse motions).

The expression “motion component Y-Y transverse to the longitudinal direction X-X” means a motion component that has a direction orthogonal to the longitudinal direction X-X and is coplanar to a support plane of the material M defined by the first beams 10. Preferably, in use said support plane is horizontal.

As will be described below, the motion component Y-Y transverse to the longitudinal direction X-X can be combined with a longitudinal motion component (i.e. parallel to the longitudinal direction X-X) and/or with a vertical motion component Z-Z (i.e. orthogonal with respect to the support plane), or it can also be the sole motion component.

Operatively, said transverse movements allow to generate relative movements between the material M and the first beams 10 transversely to said longitudinal direction X-X so as to vary the transverse resting positions of the material M on the first beams 10.

Said changes of the transverse resting positions of the material M on the first beams 10 allow to reduce the formation of cold spots in the material M during the heating/heat treatment process inside the furnace.

Alternating the displacement according to a sequence it is possible to multiply the contact points between the surface of the material M and the cold supports defined by the first beams 10, minimising the cooling due to contact and to the shadow generated by the structure.

With respect to traditional walking beam furnaces, with offset beams, the furnace 1 according to the invention allows to manage in an operatively more flexible way the reduction of the formation of cold spots in any operating condition of the furnace. Thanks to the fact that the beams (first, second or both) can be moved transversely in any longitudinal section of the furnace and at any time of the treatment, it is possible to decouple from a specific arrangement of the beams established in the design phase, offering greater flexibility in the control of the formation of the cold spots on the material M both in terms of spatial position, and of time duration.

Moreover, thanks to the fact that said changes of the transverse resting positions are obtained by means of movements of the beams (first, second or both) it is possible to repeat them cyclically, or in general according to predefined time frequencies, during the permanence of the load of material M inside the furnace 1 so as to minimise the formation of cold spots in the material M during the heating/heat treatment process inside the furnace 1.

Preferably, the first beams 10 and/or the second beams 20 are movable with movements having a motion component Y-Y transverse to the longitudinal direction X-X, independent of any movements having a motion component parallel to the longitudinal direction X-X.

In other words, the beams are configured so as to be movable transversely independently of any longitudinal movements. Operatively, this fully decouples the change of the resting positions of the material on the first beams from any movements (forwards or backwards) of the material M inside the furnace 1. With respect to traditional walking beam furnaces, with offset beams, the furnace 1 according to the invention allows to manage in an operatively more flexible way the reduction of the formation of cold spots in any operating condition of the furnace, even in case of plant downtime, i.e. when the material M cannot be moved longitudinally in the furnace, either to make it advance towards the furnace-unloading section 2b, or to make it move backwards towards the furnace-loading section 2a.

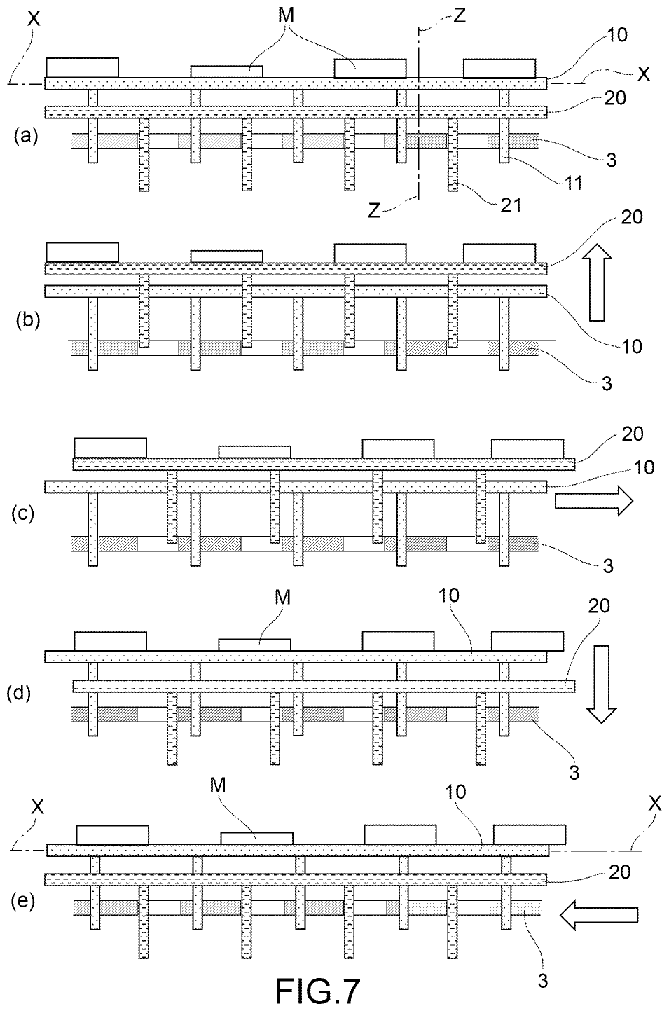

Preferably, as illustrated in FIGS. 7 a-e, the second beams 20, which are specifically intended to impart to the material motion components along the longitudinal direction X-X (i.e. to make the material move forwards or backwards in the furnace) can be moved with respect to the first beams 10 (providing the main support of the material inside the furnace) also vertically to move between:
a lowered position, wherein the second beams 20 are arranged at a height lower than that of the first beams 10 with respect to the hearth 3 of the chamber 2 leaving the material M resting on the first beams 10 (see FIGS. 7a and 7e), and
a raised position, wherein the second beams 20 are arranged at a height higher than that of the first beams 10 with respect to the hearth 3 of the chamber 2 so as to lift the material M from the support on the first beams 10 (see FIGS. 7b, 7c and 7d).

Preferably, the material M is moved in longitudinal direction by the second beams 20 when the latter are in said raised position, i.e. when the material M is raised from abutment on the first beams (see FIGS. 7b and 7c).

Operatively, the second beams 20—in their longitudinal movements—perform a cyclical round-trip movement between two predefined transverse positions, as illustrated in the sequence of the Figures from 7a to 7e. In other words, each beam 20 is provided to impose longitudinal movements to the material which is in a specific transverse section of the furnace.

Advantageously, the second beams 20 are vertically movable independently with respect to movements parallel to the longitudinal direction X-X.

Advantageously, as has already been stated above, the relative movements between the material M and the first beams 10 transversely to said longitudinal direction X-X so as to vary the transverse resting positions of the material M on the first beams 10 can be obtained in the following ways:
transversely moving only the first beams 10; or
transversely moving only the second beams 10; or
transversely moving both the first beams 10, and the second beams 20.

The expression “transversely moving a beam” means to impose on the beam at least one motion component Y-Y transverse to said longitudinal direction X-X.

Preferably, only said first beams 10 are movable with respect to the furnace chamber 2 with movements having a motion component Y-Y transverse to the longitudinal direction X-X, while said second beams 20 are movable with movements that have only a motion component parallel to the longitudinal direction X-X and/or a vertical motion component Z-Z with respect to said hearth 3 of the furnace chamber 2.

Still more preferably, said first beams 10 are movable with respect to the furnace chamber 2 with movements having only a motion component Y-Y transverse to said longitudinal direction X-X.

In accordance with a preferred embodiment, illustrated in the accompanying Figures, the first beams 10 are movable only transversely, while the second beams 20 are movable only longitudinally and vertically. In this way, as will be further discussed below, it is possible to separate transverse movements (directed at changing the transverse abutment position between material and first beams) from longitudinal movements (directed at making the material in the furnace move forwards/backwards) and at the same time to simplify the construction of the means provided to generate these movements.

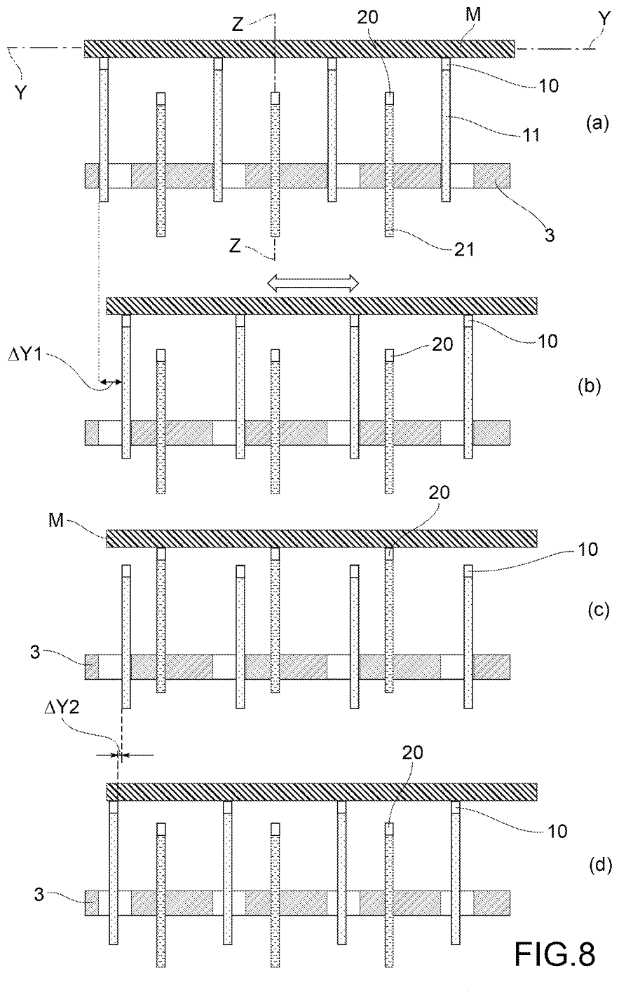

Operatively, as mentioned previously the second beams 20—in their longitudinal movements—perform a cyclical round-trip movement between two predefined transverse positions, as illustrated in the sequence of the Figures from 7a to 7e. Similarly, the first beams 10—in their transverse movements—perform a cyclical round-trip movement between predefined longitudinal positions, as shown in the sequence of FIG. 8a-b or 9a-b. In other words, each first beam 10 is provided to impose longitudinal movements to the material which is in a specific transverse section of the furnace.

In accordance with a preferred embodiment illustrated in the accompanying Figures, each of said first beams 10 and of said second beams 20 is supported respectively by first 11 and second uprights 21, which cross the hearth 3 of said furnace chamber 2 at respective through openings 11a and 21a.

In particular, as illustrated in FIG. 2, the through openings 11a and 21a are so shaped as to allow the respective uprights freedom of movement according to the respective direction of motion. In accordance with the preferred embodiment, the openings 11a engaged by the first uprights 11 are defined by slots elongated in the transverse direction Y-Y, while the openings 21a engaged by the second uprights 11 are defined by slots elongated in the longitudinal direction X-X.

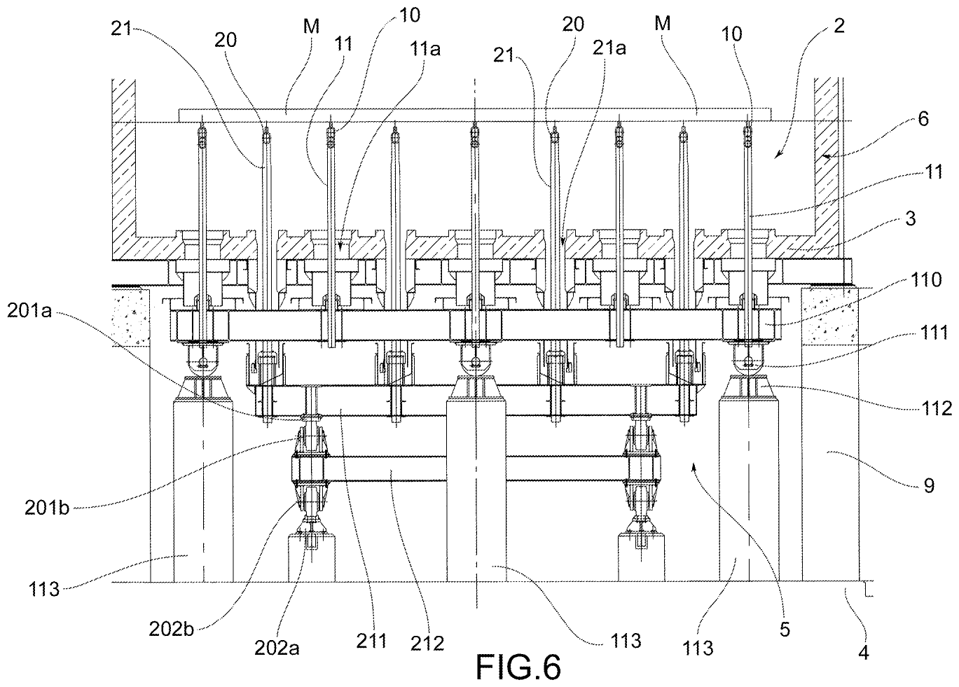

As illustrated in FIGS. 3 and 6, said first beams 10 and said second beams 20 are movable respectively by first 100 and second movement means 200 which are arranged in a technical chamber 5 made under the hearth 3 of said chamber 2 and are kinematically connected to said first 10 and second beams 20 respectively by the first 11 and the second uprights 21.

Preferably, said first movement means 100 are suitable to translate said first beams 10 only transversely to said longitudinal direction X-X.

Advantageously, said first movement means 100 are controllable so that the width of the transverse translations imposed on said first beams 10 is not less than the transverse width of said first beams 10. In this way it is assured that as a result of a transverse motion the change of the transverse resting positions between material M and first beams 10 is completed, allowing a complete reduction of the cold spot formed previously.

Preferably, said second movement means 200 comprise:
first devices 201 suitable to translate said second beams 20 parallel to said longitudinal direction X-X; and
second devices 202 suitable to move said second beams 20 vertically.

Advantageously, said first devices 201 and said second devices 202 can be operated independently of each other, so that it is possible to impart to the second beams 20 separately vertical movements and longitudinal movements.

Advantageously, said second devices 202 are controllable so that the width of the vertical translations imposed on said second beams 20 is such as to cyclically allow the passage of said second beams between said lowered position and said raised position.

In accordance with a preferred embodiment, illustrated in particular in FIG. 3, the furnace comprises a control unit 300 programmed to operate said first movement means 100 and said second movement means 200—separately or in coordination with each other—according to predefined operating sequences aimed at:
moving the material M parallel to said longitudinal direction X-X between the furnace-loading section 2a and the furnace-unloading section 2b; and/or
generating relative movements between the material M and the first beams 10 transversely to said longitudinal direction X-X so as to cyclically vary the transverse resting positions of the material M on the first beams 10.

The control unit can be of any type, for example electronic.

Preferably, to vary the transverse resting positions of the material M on the first beams 10 said control unit 300 is programmed to operate said first movement means 100 in coordination with at least the second devices 202 of the second movement means 200, i.e. with the devices provided to move vertically the second beams 20. In this way, the lateral translation movements of the first beams 10 can be associated to vertical movements of the second beams 20 and hence of the material M.

The control unit 300 can be programmed to operate the first means 100 and the first devices 201 according to different operating sequences. Advantageously, the control unit 300 can be programmed to always execute the same operating sequence or optionally it can be programmed to execute different operating sequences at different times.

In more detail, a first operating sequence (illustrated schematically in the sequence of FIGS. 8a-d) can have the following steps:
a) operating the second devices 202 to maintain or bring said second beams 20 into the lowered position, leaving the material M resting on the first beams 10 in first transverse resting positions (see FIG. 8a);
b) operating the first movement means 100 to translate said first beams 10 transversely to said longitudinal direction by a first transverse distance ΔY1 from an initial transverse position to a final transverse position, dragging the material M resting on them in the same transverse translation (see FIG. 8b);
c) operating the second devices 202 to bring said second beams 20 into the raised position, thereby lifting the material M from its support on the first beams 10 (see FIG. 8c); and
d) operating the first movement means 100 to translate said first beams 10 transversely to said longitudinal direction by a second transverse distance ΔY2 so as to move them from said final transverse position (see FIGS. 8c-8d);
e) operating the second devices 202 to return said second beams 20 to the lowered position, thereby bringing the material M resting on the first beams 10 to second transverse resting positions transversely spaced apart from said first transverse resting positions by said second transverse distance ΔY2 (see FIG. 8d).

Said second transverse distance ΔY2 can be equal to or different from said first transverse distance ΔY1, according to the contingent operating conditions (for example, according to the transverse extension of the material M and to the need not to lose supports at its ends).

Operatively, the first operating sequence described above provides for transversely moving both the material M and the first beams 10 with respect to the furnace chamber.

Alternatively, as described below, it is possible to provide a different operating sequence which provides for transversely moving only the first beams 10 with respect to the furnace chamber, leaving instead transversely motionless the material M with respect to the furnace chamber.

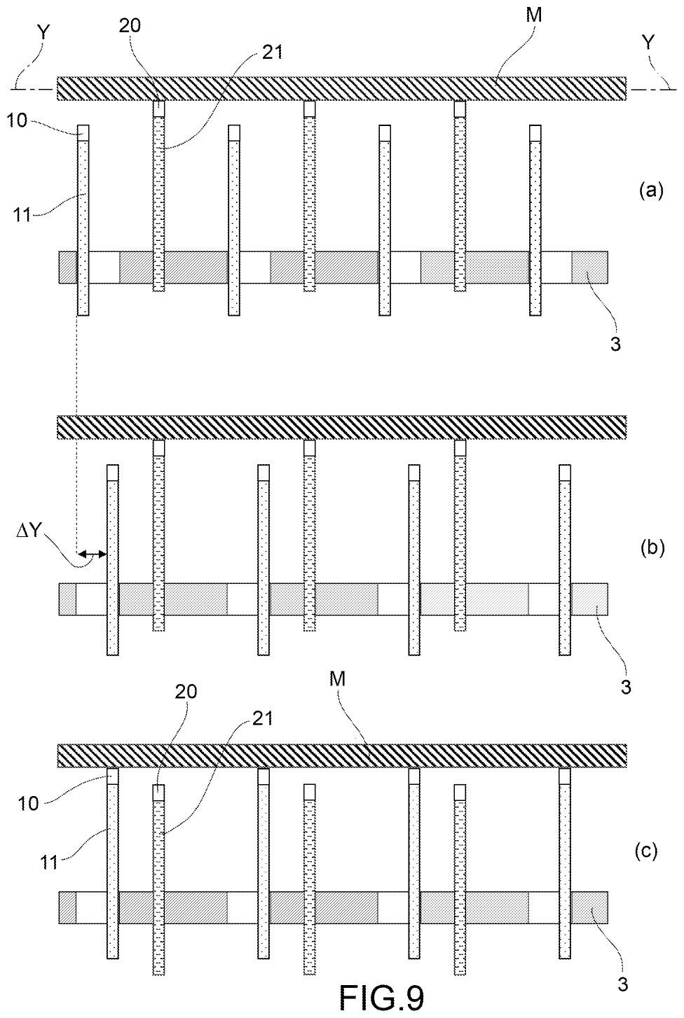

In more detail, a second operating sequence (illustrated schematically in the sequence of FIGS. 9 a-c) can have the following steps:
a) operating the second devices 202 to maintain or bring said second beams 20 into the raised position, thereby lifting the material M from the support on the first beams 10 from first transverse resting positions (see FIG. 9a);
b) operating the first movement means 100 to translate said first beams 10 transversely to said longitudinal direction by a transverse distance ΔY from an initial transverse position to a final transverse position (see FIG. 9b); and
c) operating the second devices 202 to bring said second beams 20 into the lowered position, thereby bringing the material M to rest on the first beams 10 in second transverse resting positions transversely spaced apart from said first transverse resting positions by said transverse distance ΔY (see FIG. 9c).

Advantageously, the two operating sequences described above can be carried out:
without involving the second devices 202 (of the second movement means 200), provided to translate longitudinally the second beams 20 and hence the material M; or
involving also the second devices 202 (of the second movement means 200), provided to translate longitudinally the second beams 20 and hence the material M.

In more detail, the control unit 300 is programmed to operate said first movement means 100 in coordination only with the second devices 202 of the second movement means 200 (provided for vertical movements), leaving inactive the first devices 202 of the second movement means 200 (provided for longitudinal movements) so as to vary the transverse resting positions of the material M on the first beams 10 without imparting on said material M a motion with longitudinal component between said furnace-loading section 2a and said furnace-unloading section 2b. In this way, the operating flexibility of the furnace 1 is increased, making it possible to vary the transverse resting positions even in conditions of furnace downtime.

Advantageously, the control unit 300 can also be programmed to operate said first movement means 100 in coordination with both the second devices 202, and with the first devices 201 of the second movement means 200, so as to vary the transverse resting positions of the material M on the first beams 10 while imparting on said material M a motion with longitudinal component between said furnace-loading section 2a and said furnace-loading section 2b.

As has already been described previously, in accordance with a preferred embodiment illustrated in the accompanying Figures, each of said first beams 10 and of said second beams 20 is supported respectively by first 11 and second uprights 21, which cross the hearth 3 of said furnace chamber 2 at respective through openings 11a and 21a. The first beams 10 and the second beams 20 are movable respectively by said first 100 and second movement means 200 which are arranged in the technical chamber 5 made under the hearth 3 of said chamber 2 and are kinematically connected to said first 10 and second beams 20 respectively by the first 11 and the second uprights 21.

Preferably, as illustrated in particular in FIGS. 3 and 6, the first uprights 11 of said first beams 10 are all connected to each other by a first support structure 110 that is kinematically associated with said first movement means 100 for translating—with the associated first uprights 11 and first beams 10—transversely with respect to the hearth 3 of said chamber 2.

In particular, said first support structure 110 is arranged in the technical chamber 5 made between the hearth 3 of said chamber 2 and a support base 4 of the furnace 1.

In more detail, the first support structure 110 can consist of a frame, provided inferiorly with a plurality of first wheels 111, each of which has its axis of rotation parallel to the longitudinal direction X-X. Each of said first wheels 111 is engaged to roll in transverse direction Y-Y on a first guide 112, having an extension in transverse direction sufficient to allow the required transverse movements of the first support structure 110 and of the associated first uprights 11 and first beams 10.

Said first support structure 110 is maintained at a fixed vertical elevation with respect to the hearth 3 of the chamber 2 and from the support base 4 of the furnace 1, in particular, by a plurality of first columns 113 that extend in height from the support base 4. On the top of each column 113 is positioned one of said first guides 112.

Advantageously, the translation of said first support structure 110 is obtained motorising at least a part of said first wheels 111 so as to control their rotation motion. In particular, as illustrated in FIG. 3, it is possible to connect to a common gearmotor system 114 a plurality of first wheels 111 having the respective axes of rotation aligned longitudinally to each other. The remaining first wheels can be idle so as to follow passively the movements of the motorised wheels.

Advantageously, the translation of the first support structure 110 can be obtained without motorising the wheels 111, but by means of a system of pushers, for example consisting of pneumatic cylinders, operating between the containment structure 6 of the furnace 1 and the structure itself.

Preferably, as illustrated in particular in FIGS. 3 and 6, the second uprights 21 of said second beams 20 are all connected to each other by a second support structure 211 which is kinematically associated with the first devices 201 of said second movement means 200 for translating—with the associated second uprights 21 and second beams 20—parallel to said longitudinal direction X-X with respect to a third support structure 212.

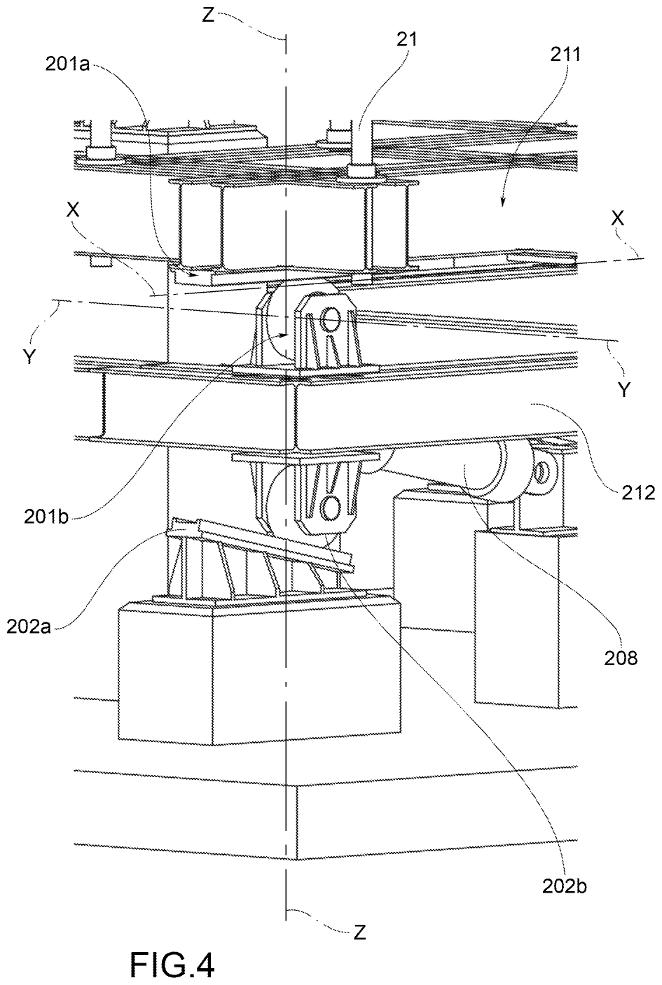

In more detail, as illustrated in FIGS. 3 and 4, the second support structure 211 is made translatable with respect to the third support structure 212 by a system of longitudinal guides 201a and wheels with transverse axis 201b interposed between second and third support structure. Preferably, the wheels 201b are all idle and the translation of the second structure 211 with respect to the third structure 212 is obtained by means of a system of pushers 204, for example consisting of one or more pneumatic cylinders, operating between the containment structure 6 of the furnace 1 and the second structure itself.

In particular, said second and third support structure 211, 212 are positioned in said technical chamber 5 and they can both consist of a frame.

In turn said third support structure 212 is kinematically associated with the second devices 202 of said second movement means 200 for moving vertically—together with the second support structure 211—with respect to the hearth 3 of said chamber 2.

In more detail, the third structure 212 is provided with a plurality of wheels 202b with transverse axis of rotation, each of which is engaged to roll in longitudinal direction X-X on an inclined guide 202b. Said inclined guides have sufficient inclination and extension to allow the vertical displacement of the second beams between said lowered position and said raised position. Preferably, the wheels 202b are all idle and the movement along the inclined guides 202a is imparted by a system of pushers 208, for example consisting of one or more pneumatic cylinders, operating between the containment structure 6 of the furnace 1 and the third structure itself.

Operatively, the longitudinal movements imposed on the third structure 212 in its motion along the inclined guides are not transmitted to the second structure 211 thanks to the presence of the idle wheels 201b.

The system of wheels/inclined guides/pushers can be replaced by a system of hydraulic jacks (not illustrated). Considering the weights at play, however, the system of wheels/inclined guides/pushers is more efficient and economical.

The invention allows to obtain numerous advantages, already described in part.

The furnace with movable beam handling system according to the invention that allows to reduce the formation of cold spots in the material during the heating/heat treatment process inside the furnace in an operatively more flexible way compared to traditional walking beam furnaces.

The furnace with movable beam handling system according to the invention allows to reduce the formation of cold spots in the material during the heating/heat treatment process inside the furnace even in cases of plant downtime, i.e. even if the material cannot be made to advance or move backwards inside the furnace.

The furnace with movable beam handling system according to the invention is operatively simple to manage.

The invention thus conceived therefore achieves its intended purposes.

Obviously, in its practical realisation it may also assume different forms and configurations from the one illustrated above, without thereby departing from the present scope of protection.

Moreover, all details may be replaced by technical equivalent elements and the dimensions, the forms and the materials employed may be any, depending on the needs.

1. Furnace with movable beam load handling system, in particular for heating or heat treatment of ferrous or non-ferrous metallic material, comprising:
a furnace chamber extending between a furnace-loading section and a furnace-unloading section of the material along a longitudinal direction;
first beams, arranged inside said chamber and defining a plurality of main supports for the material to be treated in said chamber, extending in length between said furnace-loading section and said furnace-unloading section, spaced transversely apart from each other to support said material in different transverse positions in the furnace chamber, raised from a hearth of said chamber;
second beams, arranged inside said chamber and defining a plurality of temporary supports for the material, extending in length between said furnace-loading section and said furnace-unloading section, spaced transversely apart from each other and alternating with said main supports, wherein said second beams are cyclically movable with respect to the first beams so as to impart to said material a movement between said furnace-loading section and said furnace-unloading section having a motion component parallel to said longitudinal direction,
characterized in that said first beams or said second beams, or both the first and the second beams are movable with respect to the furnace chamber with movements having a motion component transverse to said longitudinal direction, in order to generate relative movements between the material and the first beams transversally to said longitudinal direction so as to cyclically vary the transverse resting positions of the material on the first beams.

2. The furnace according to claim 1, wherein said first beams and/or said second beams are movable with movements having a motion component transverse to said longitudinal direction independent of any movements having a motion component parallel to said longitudinal direction.

3. The furnace according to claim 1, wherein said second beams are movable with respect to the first beams also vertically to move between:
a lowered position, wherein said second beams are arranged at a height lower than that of the first beams with respect to the hearth of said chamber leaving the material resting on the first beams, and
a raised position, wherein said second beams are arranged at a height higher than that of the first beams with respect to the hearth of said chamber so as to lift the material from the support on the first beams.

4. The furnace according to claim 3, wherein said second beams are vertically movable independently with respect to movements parallel to said longitudinal direction.

5. The furnace according to claim 1, wherein only said first beams are movable with respect to the furnace chamber with movements having a motion component transverse to said longitudinal direction, while said second beams are movable with movements that have only a motion component parallel to said longitudinal direction and/or a vertical motion component with respect to said hearth.

6. The furnace according to claim 5, wherein said first beams are movable with respect to the furnace chamber with movements having only a motion component transverse to said longitudinal direction.

7. The furnace according to claim 1 ms, wherein each of said first beams and said second beams is supported respectively by first and second uprights, which cross the hearth of said furnace chamber at respective through openings and wherein said first beams and said second beams are movable respectively by first and second movement means which are arranged in a technical chamber made under the hearth of said chamber and are kinematically connected to said first and second beams respectively by the first and the second uprights.

8. The furnace according to claim 6, wherein said first movement means are suitable to translate said first beams only transversely to said longitudinal direction.

9. The furnace according to claim 8, wherein said first movement means are controllable so that the width of the transverse translations imposed on said first beams is not less than the transverse width of said first beams.

10. The furnace according to claim 6, wherein said second movement means comprise:
first devices suitable to translate said second beams parallel to said longitudinal direction; and
second devices suitable to move said second beams vertically, wherein preferably said first devices and said second devices can be operated independently of each other.

11. The furnace according to claim 310, wherein said second devices are controllable so that the width of the vertical translations imposed on said second beams is such as to cyclically allow the passage of said second beams between said lowered position and said raised position.

12. The furnace according to claim 8, comprising a control unit programmed to operate said first movement means and said second movement means—separately or in coordination with each other—according to predefined operating sequences aimed at:
moving the material parallel to said longitudinal direction between said furnace-loading section and said furnace-unloading section; and/or
generating relative movements between the material and the first beams transversely to said longitudinal direction so as to cyclically vary the transverse resting positions of the material on the first beams.

13. The furnace according to claim 12, wherein said control unit is programmed to operate said first movement means in coordination with at least the second devices of the second movement means to vary the transverse resting positions of the material on the first beams according to the following operating sequence:
a) operating the second devices to maintain or bring said second beams into the lowered position, leaving the material resting on the first beams in first transverse resting positions;
b) operating the first movement means to translate said first beams transversely to said longitudinal direction by a first transverse distance from an initial transverse position to a final transverse position, dragging the material resting on them in the same transverse translation;
c) operating the second devices to bring said second beams into the raised position, thereby lifting the material from its support on the first beams; and
d) operating the first movement means to translate said first beams transversely to said longitudinal direction by a second transverse distance so as to move them from said final transverse position;
e) operating the second devices to return said second beams to the lowered position, thereby bringing the material resting on the first beams to second transverse resting positions transversely spaced apart from said first transverse resting positions by said second transverse distance,
wherein said second transverse distance may be the same as or different from said first transverse distance.

14. The furnace according to claim 12, wherein said control unit is programmed to operate said first movement means in coordination with at least the second devices of the second movement means to vary the transverse resting positions of the material on the first beams according to the following operating sequence:
a) operating the second devices to maintain or bring said second beams into the raised position, thereby lifting the material from the support on the first beams from first transverse resting positions;
b) operating the first movement means to translate said first beams transversely to said longitudinal direction by a transverse distance from an initial transverse position to a final transverse position; and
c) operating the second devices to bring said second beams into the lowered position, thereby bringing the material to rest on the first beams in second transverse resting positions transversely spaced apart from said first transverse resting positions by said transverse distance (ΔY).

15. The furnace according to claim 13, wherein said control unit is programmed to operate said first movement means in coordination only with the second devices of the second movement means, leaving the first devices of the second movement means inactive so as to vary the transverse resting positions of the material on the first beams without imparting on said material a motion between said furnace-loading section and said furnace unloading section having a motion component parallel to said longitudinal direction.

16. The furnace according to claim 13, wherein said control unit is programmed to operate said first movement means in coordination with both the second devices and with the first devices of the second movement means, so as to vary the transverse resting positions of the material on the first beams while imparting on said material a motion between said furnace-loading section and said furnace unloading section having a motion component parallel to said longitudinal direction.

17. The furnace according to claim 7, wherein the first uprights of said first beams are all connected to each other by a first support structure that is kinematically associated with said first movement means for translating—with the associated first uprights and first beams—transversely with respect to the hearth of said chamber, wherein preferably said first support structure is arranged in said technical chamber made between the hearth of said chamber and a support base of said furnace.

18. The furnace according to claim 10, wherein the second uprights of said second beams are all connected to each other by a second support structure which is kinematically associated with the first devices of said second movement means for translating—with the associated second uprights and second beams—parallel to said longitudinal direction with respect to a third support structure
and wherein said third support structure is kinematically associated with the second devices of said second movement means for moving vertically—together with said second support structure—with respect to the hearth of said chamber 2), wherein preferably said second and third support structures are arranged in said technical chamber.
